(19) United States
(12) Patent Application Publication
(10) Pub. No.: US 2019/0291863 A1
(43) Pub. Date: Sep. 26, 2019

(54) VERTICAL TAKEOFF AND LANDING AIRCRAFT WITH TILTED-WING CONFIGURATIONS

(71) Applicant: A^3 BY AIRBUS LLC, SANTA CLARA, CA (US)

(72) Inventors: Rodin Lyasoff, San Francisco, CA (US); Geoffrey C. Bower, Sunnyvale, CA (US); Zachary Lovering, Sunnyvale, CA (US)

(73) Assignee: A^3 BY AIRBUS LLC, SANTA CLARA, CA (US)

(21) Appl. No.: 16/302,274

(22) PCT Filed: Feb. 16, 2017
(86) PCT No.: PCT/US17/18135

§ 371 Date: Nov. 16, 2018

Related U.S. Application Data
(60) Provisional application No. 62/338,294, filed on May 18, 2016.
(60) Provisional application No. 62/338,273, filed on May 18, 2016.

(51) Int. Cl. B64C 29/00; B64C 39/02; B64D 27/24; G05D 1/10

(52) U.S. Cl. CPC B64C 29/0033; B64C 39/024; B64D 27/24; G05D 1/102; B64C 2201/128; B64C 2201/024; B64C 2201/042; B64C 2201/108; B64C 2201/141; B64C 2201/021

(57) ABSTRACT

The present disclosure pertains to self-piloted, electric vertical takeoff and landing (VTOL) aircraft that are safe, low-noise, and cost-effective to operate for cargo-carrying and passenger-carrying applications over relatively long ranges. A VTOL aircraft has a tandem-wing configuration with one or more propellers mounted on each wing to provide propeller redundancy, allowing sufficient propulsion and control to be maintained in the event of a failure of any of the propellers or other flight control devices. The arrangement also allows the propellers to be electrically-powered, yet capable of providing sufficient thrust with a relatively low blade speed, which helps to reduce noise. In addition, each wing is designed to tilt, thereby rotating the propellers, as the aircraft transitions between forward flight and hover flight. While in the hover flight, the propellers may be offset from vertical so that horizontal thrust components of the propellers may be used to provide efficient yaw control.

### CROSS REFERENCE TO RELATED APPLICATIONS

This application claims priority to U.S. Provisional Application No. 62/338,273, entitled “Vertical Takeoff and Landing Aircraft with Tilted-Wing Configurations” and filed on May 18, 2016, which is incorporated herein by reference. This application also claims priority to U.S. Provisional Application No. 62/338,294, entitled “Autonomous Aircraft for Passenger or Cargo Transportation” and filed on May 18, 2016, which is incorporated herein by reference.

### BACKGROUND

Vertical takeoff and landing (VTOL) aircraft offer various advantages over other types of aircraft that require a runway. However, the design of VTOL aircraft can be complex making it challenging to design VTOL aircraft that are cost-effective and safe for carrying passengers or cargo. As an example, a helicopter is a common VTOL aircraft that has been conventionally used to transport passengers and cargo. In general, helicopters use a large rotor to generate both lift and forward thrust, requiring the rotor to operate at high speeds. The design of the rotor can be complex, and failure of the rotor can be catastrophic. In addition, operation of a large rotor at high speeds generates a significant amount of noise that can be a nuisance and potentially limit the geographic regions at which the helicopter is permitted to operate. Helicopters also can be expensive to manufacture and operate, requiring a significant amount of fuel, maintenance, and the services of a skilled pilot.

Due to the shortcomings and costs of conventional helicopters, electrically-powered VTOL aircraft, such as electric helicopters and unmanned aerial vehicles (UAVs), have been considered for certain passenger-carrying and cargo-carrying applications. Using electrical power to generate thrust and lift may help somewhat to reduce noise, but it is has proven challenging to design electric VTOL aircraft that are capable of accommodating the weight required for many applications involving the transport of passengers or cargo without unduly limiting the aircraft's range. Also, operational expenses can be lowered if VTOL aircraft can be designed to be self-piloted, without requiring the services of a human pilot. However, safety is a paramount concern, and many consumers are wary of self-piloted aircraft for safety reasons.

A heretofore unaddressed need exists in the art for a self-piloted, electrically-powered, VTOL aircraft that is safe, low-noise, and cost-effective to operate for cargo-carrying and passenger-carrying applications over relatively long ranges.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 depicts a perspective view of a self-piloted VTOL aircraft in accordance with some embodiments of the present disclosure.

FIG. 2A depicts a front view of a self-piloted VTOL aircraft, such as is depicted by FIG. 1, with flight control surfaces actuated for controlling roll and pitch.

FIG. 2B depicts a perspective view of a self-piloted VTOL aircraft, such as is depicted by FIG. 2A.

FIG. 3 is a block diagram illustrating various components of a VTOL aircraft, such as is depicted by FIG. 1.

FIG. 4 is a block diagram illustrating a flight-control actuation system, such as is depicted by FIG. 3, in accordance with some embodiments of the present disclosure.

FIG. 5 depicts a perspective view of a self-piloted VTOL aircraft, such as is depicted by FIG. 1, in a hover configuration in accordance with some embodiments of the present disclosure.

FIG. 6 depicts a top view of a self-piloted VTOL aircraft, such as is depicted by FIG. 5, in a hover configuration with the wings tilted such that thrust from wing-mounted propellers is substantially vertical.

FIG. 7 depicts a perspective view of a self-piloted VTOL aircraft, such as is depicted by FIG. 1, transitioning between a forward-flight configuration and a hover configuration in accordance with some embodiments of the present disclosure.

FIG. 8 depicts a side view of a wing for a self-piloted VTOL aircraft, such as is depicted by FIG. 1, in accordance with some embodiments of the present disclosure.

FIG. 9 depicts a side view of the wing of FIG. 8 after wing rotation.

FIG. 10 depicts a perspective view of a self-piloted VTOL aircraft, such as is depicted by FIG. 1, in accordance with some embodiments of the present disclosure.

FIG. 11 depicts a perspective view of a self-piloted VTOL aircraft, such as is depicted by FIG. 10, in accordance with some embodiments of the present disclosure.

FIG. 12 depicts a side view of a self-piloted VTOL aircraft, such as is depicted by FIG. 5, in accordance with some embodiments of the present disclosure.

FIG. 13 depicts a top view of a self-piloted VTOL aircraft in a hover configuration in accordance with some embodiments of the present disclosure.

### DETAILED DESCRIPTION

The present disclosure generally pertains to vertical takeoff and landing (VTOL) aircraft that have tilted-wing configurations. A self-piloted, electric, VTOL aircraft in accordance with some embodiments of the present disclosure has a tandem-wing configuration with one or more propellers mounted on each wing in an arrangement that provides propeller redundancy, allowing sufficient propulsion and control to be maintained in the event of a failure of one or more of the propellers or other flight control devices. The arrangement also allows the propellers to be electrically-powered, yet capable of providing sufficient thrust with a relatively low blade speed, which helps to reduce noise.

In addition, each wing is designed to tilt, thereby rotating the propellers, as the aircraft transitions between a forward-flight configuration and a hover configuration. In this regard, for the forward-flight configuration, the propellers are positioned to provide forward thrust while simultaneously blowing air over the wings so as to improve the lift characteristics (e.g., lift-to-drag ratio) of the wings and also help keep the wing dynamics substantially linear, thereby reducing the likelihood of stalls. For the hover configuration, the wings are tilted in order to position the propellers to provide upward thrust for controlling vertical movement of the aircraft. While in the hover configuration, the wings and propellers may be offset from vertical to provide efficient yaw control.

Specifically, in the hover configuration, the propellers may be slightly offset from vertical in order to generate horizontal thrust components that can be used to induce movements about the yaw axis, as may be desired. The wings also may have movable flight control surfaces that can be adjusted to redirect the airflow from the propellers to provide additional yaw control in the hover configuration. These same flight control surfaces may be used to provide pitch and roll control in the forward-flight configuration. During a transition from the hover configuration to the forward-flight configuration, the tilt of the wings can be adjusted in order to keep the wings substantially aligned with the aircraft's flight path further helping to keep the wing dynamics linear and prevent a stall.

Accordingly, a self-piloted, electric, VTOL aircraft having improved safety and performance can be realized. Using the configurations described herein, it is possible to design a self-piloted, electric, VTOL aircraft that is safe and low-noise. An exemplary aircraft designed to the teachings of this application can have a small footprint (e.g., a tip-to-tip wingspan of about 11 meters) and mass (e.g., about 600 kilograms) and is capable of supporting a payload of about 100 kilograms over a range of up to about 80 kilometers at speeds of about 90 knots. Further, such an aircraft may be designed to produce a relatively low amount of noise such as about 61 decibels as measured on the ground when the aircraft is at approximately 100 feet. The same or similar design may be used for aircraft of other sizes, weights, and performance characteristics.

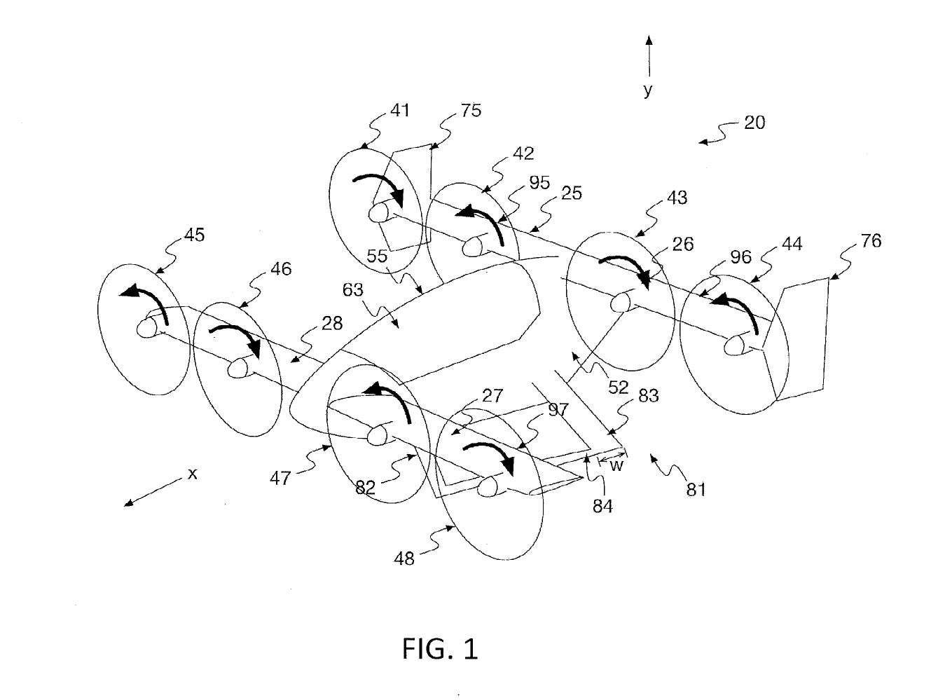

FIG. 1 depicts a VTOL aircraft 20 in accordance with some embodiments of the present disclosure. The aircraft 20 is autonomous or self-piloted in that it is capable of flying passengers or cargo to selected destinations under the direction of an electronic controller without the assistance of a human pilot. As used herein, the terms “autonomous” and “self-piloted” are synonymous and shall be used interchangeably. Further, the aircraft 20 is electrically powered thereby helping to reduce operation costs. Any conventional way of providing electrical power is contemplated. If desired, the aircraft 20 may be equipped to provide a passenger with flight control so that the passenger may pilot the aircraft at least temporarily rather than rely exclusively on self-piloting by a controller.

As shown by FIG. 1, the aircraft 20 has a tandem-wing configuration with a pair of rear wings 25, 26 mounted close to the rear of a fuselage 33 and a pair of forward wings 27, 28, which may also be referred to as “canards,” mounted close to the front of the fuselage 33. Each wing 25-28 has camber and generates lift (in the y-direction) when air flows over the wing surfaces. The rear wings 25, 26 are mounted higher than the forward wings 27, 28 so as to keep them out of the wake of the forward wings 27, 28.

In the tandem-wing configuration, the center of gravity of the aircraft 20 is between the rear wings 25, 26 and the forward wings 27, 28 such that the moments generated by lift from the rear wings 25, 26 counteract the moments generated by lift from the forward wings 27, 28 in forward flight. Thus, the aircraft 20 is able to achieve pitch stability without the need of a horizontal stabilizer that would otherwise generate lift in a downward direction, thereby inefficiently counteracting the lift generated by the wings. In some embodiments, the rear wings 25, 26 have the same wingspan, aspect ratio, and mean chord as the forward wings 27, 28, but the sizes and configurations of the wings may be different in other embodiments.

The forward wings 27, 28 may be designed to generate more lift than the rear wings 25, 26, such as by having a slightly higher angle of attack or other wing characteristics different than the rear wings 25, 26. As an example, in some embodiments, the forward wings 27, 28 may be designed to carry about 60% of the aircraft's overall load in forward flight. Having a slightly higher angle of attack also helps to ensure that the forward wings 27, 28 stall before the rear wings 25, 26, thereby providing increased stability. In this regard, if the forward wings 27, 28 stall before the rear wings 25, 26, then the decreased lift on the forward wings 27, 28 resulting from the stall should cause the aircraft 20 to pitch forward since the center of gravity is between the forward wings 27, 28 and the rear wings 25, 26. In such event, the downward movement of the aircraft's nose should reduce the angle of attack on the forward wings 27, 28, breaking the stall.

In some embodiments, each wing 25-28 has a tilted-wing configuration that enables it to be tilted relative to the fuselage 33. In this regard, as will be described in more detail below, the wings 25-28 are rotatably coupled to the fuselage 33 so that they can be dynamically tilted relative to the fuselage 33 to provide vertical takeoff and landing (VTOL) capability and other functions, such as yaw control and improved aerodynamics, as will be described in more detail below.

A plurality of propellers 41-48 are mounted on the wings 25-28. In some embodiments, two propellers are mounted on each wing 25-28 for a total of eight propellers 41-48, as shown by FIG. 1, but other numbers of propellers 41-48 are possible in other embodiments. Further, it is unnecessary for each propeller to be mounted on a wing. As an example, the aircraft 20 may have one or more propellers (not shown) that are coupled to the fuselage 33, such as at a point between the forward wings 27, 28 and the rear wings 25, 26, by a structure (e.g., a rod or other structure) that does not generate lift. Such a propeller may be rotated relative to the fuselage 33 by rotating the rod or other structure that couples the propeller to the fuselage 33 or by other techniques.

For forward flight, the wings 25-28 and propellers 41-48 are positioned as shown by FIG. 1 such that thrust generated by the propellers 41-48 is substantially horizontal (in the x-direction) for moving the aircraft 20 forward. Further, each propeller 41-48 is mounted on a respective wing 25-28 and is positioned in front of the wing's leading edge such that the propeller blows air over the surfaces of the wing, thereby improving the wing's lift characteristics. For example, propellers 41, 42 are mounted on and blow air over the surfaces of wing 25; propellers 43, 44 are mounted on and blow air over the surfaces of wing 26; propellers 45, 46 are mounted on and blow air over the surfaces of wing 28; and propellers 47, 48 are mounted on and blow air over the surfaces of wing 27. Rotation of the propeller blades, in addition to generating thrust, also increases the speed of the airflow around the wings 25-28 such that more lift is generated by the wings 25-28 for a given airspeed of the aircraft 20. In other embodiments, other types of propulsion devices may be used to generate thrust it, and it is unnecessary for each wing 25-28 to have a propeller or other propulsion device mounted thereon.

In some embodiments, the blades of the propellers 41-48 are sized such that nearly the entire width of each wing 25-28 is blown by the propellers 41-48. As an example, the blades of the propellers 41, 42 in combination span across nearly the entire width of the wing 25 such that air is blown by the propellers 41, 42 across the entire width or nearly the entire width (e.g., about 90% or more) of the wing 25. Further, the blades of the propellers 43-48 for the other wings 26-28 similarly span across nearly the entire widths of the wings 26-28 such that air is blown by the propellers 43-48 across the entire width or nearly the entire width of each wing 26-28. Such a configuration helps to increase the performance improvements described above for blown wings. However, in other embodiments, air can be blown across a smaller width for any wing 25-28, and it is unnecessary for air to be blown over each wing 25-28.

As known in the art, when an airfoil is generating aerodynamic lift, a vortex (referred to as a “wingtip vortex”) is typically formed by the airflow passing over the wing and rolls off of the wing at the wingtip. Such a wingtip vortex is associated with a significant amount of induced drag that generally increases as the intensity of the wingtip vortex increases.

The end of each rear wing 25, 26 forms a respective winglet 75, 76 that extends generally in a vertical direction. The shape, size, and orientation (e.g., angle) of the winglets 75, 76 can vary in different embodiments. In some embodiments, the winglets 75, 76 are flat airfoils (without camber), but other types of winglets are possible. As known in the art, a winglet 75, 76 can help to reduce drag by smoothing the airflow near the wingtip helping to reduce the intensity of the wingtip vortex. The winglets 75, 76 also provide lateral stability about the yaw axis by generating aerodynamic forces that tend to resist yawing during forward flight. In other embodiments, the use of winglets 75, 76 is unnecessary, and other techniques may be used to control or stabilize yaw. Also, winglets may be formed on the forward wings 27, 28 in addition to or instead of the rear wings 25, 26.

In some embodiments, at least some of the propellers 41, 44, 45, 48 are wing-tip mounted. That is, the propellers 41, 44, 45, 48 are mounted at the ends of wings 25-28, respectively, near the wingtips such that these propellers 41, 44, 45, 48 blow air over the wingtips. The blades of the propellers 45, 48 at the ends of the forward wings 27, 28 rotate counter-clockwise and clockwise, respectively, when viewed from the front of the aircraft 20. Thus, the blades of the propellers 45, 48 are moving in a downward direction when they pass the wingtip (i.e., on the outboard side of the propeller 45, 48), and such blades are moving in an upward direction when they pass the wing 27, 28 on the inboard side of the propeller 45, 48. As known in the art, a propeller generates a downwash (i.e., a deflection of air in a downward direction) on one side where the propeller blades are moving downward and an upwash (i.e., a deflection of air in an upward direction) on a side where the propeller blades are moving upward. An upwash flowing over a wing tends to increase the effective angle of attack for the portion of the wing over which the upwash flows, thereby often causing such portion to generate more lift, and a downwash flowing over a wing tends to decrease the effective angle of attack for the portion of the wing over which the downwash flows, thereby often causing such portion to generate less lift.

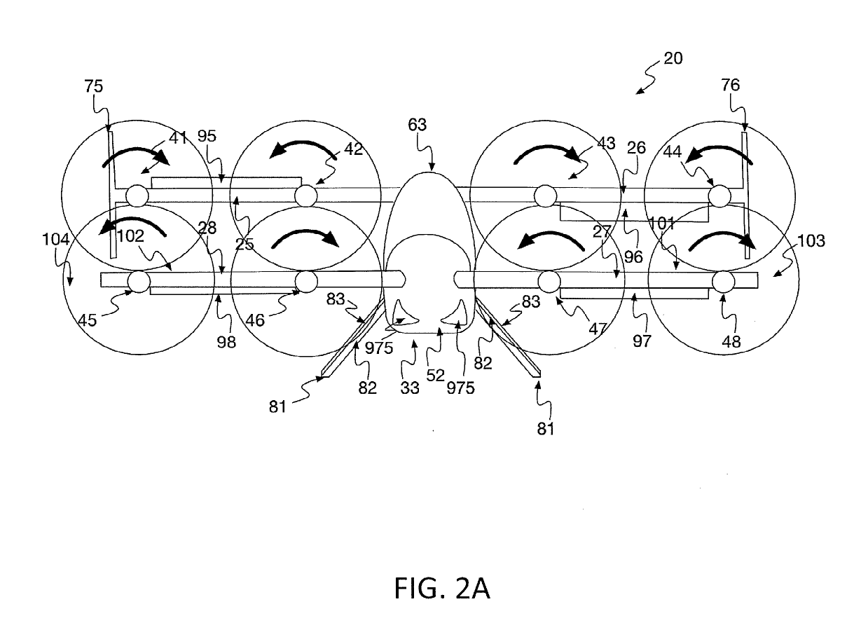

Due to the direction of blade rotation of the propellers 45, 48, each of the propellers 45, 48 generates an upwash on its inboard side and downwash on its outboard side. The portions of the wings 27, 28 behind the propellers 45, 48 on their inboard sides (indicated by reference arrows 101, 102 in FIG. 2A) generate increased lift due to the upwash from the propellers 45, 48. Further, due to the placement of the propellers 45, 48 at the wingtips, a substantial portion of the downwash of each propeller 45, 48 does not pass over a forward wing 27, 28 but rather flows in a region (indicated by reference arrows 103, 104 in FIG. 2A) outboard from the wingtip. Thus, for each forward wing 27, 28, increased lift is realized from the upwash of one of the propellers 45, 48 without incurring a comparable decrease in lift from the downwash, resulting in a higher lift-to-drag ratio.

For controllability reasons, which will be described in more detail below, it may be desirable to design the aircraft 20 such that the outer propellers 41, 44 on the rear wings 25, 26 do not rotate their blades in the same direction and the outer propellers 45, 48 on the forward wings 27, 28 do not rotate their blades in the same direction. Thus, in some embodiments, the outer propellers 44, 45 rotate their blades in a counter-clockwise direction opposite to that of the propellers 41, 48. In such embodiments, the placement of the propellers 41, 44 at the wingtips does not have the same performance benefits described above for the outer propellers 45, 48 of the forward wings 27, 28. However, blowing air on the winglets 75, 76 provides at least some performance improvement associated with the winglets 75, 76. More specifically, the upwash from the propellers 41, 44 is in a direction close to the direction of lift of the winglets 75, 76. This allows the winglets 75, 76 to be designed smaller for a desired level of stability resulting in less drag from the winglets 75, 76. In addition, in embodiments for which the forward wings 27, 28 are designed to provide more lift than the rear wings 25, 26, as described above, selecting outer propellers 45, 48 on the forward wings 27, 28 to realize the performance benefits associated with wingtip-mounting results in a more efficient configuration. In this regard, such performance benefits have a greater overall effect when applied to a wing generating greater lift.

The fuselage 33 comprises a frame 52 on which a removable passenger module 55 and the wings 25-28 are mounted. The passenger module 55 has a floor (not shown in FIG. 1) on which at least one seat (not shown in FIG. 1) for at least one passenger is mounted. The passenger module 55 also has a transparent canopy 63 through which a passenger may see. As will be described in more detail hereafter, the passenger module 55 may be removed from the frame 52 and replaced with a different module (e.g., a cargo module) for changing the utility of the aircraft 20, such as from passenger-carrying to cargo-carrying.

As shown by FIG. 1, the illustrative aircraft has landing struts 83, referred to herein as “rear struts,” that are aerodynamically designed for providing lateral stability about the yaw axis. In this regard, the rear struts 83 form flat airfoils (without camber) that generate aerodynamic forces that tend to resist yawing during forward flight. In other embodiments, the rear struts 83 may form other types of airfoils as may be desired. In the embodiment depicted by FIG. 1, each rear strut 83 forms part of a respective landing skid 81 that has a forward strut 82 joined to the strut 83 by a horizontal bar 84. In other embodiments, the landing gear may have other configurations. For example, rather than using a skid 81, the rear struts may be coupled to wheels. The use of the rear struts 83 for providing lateral stability permits the size of the winglets 75, 76 to be reduced, thereby reducing drag induced by the winglets 75, 76, while still achieving a desired level of yaw stability. In some embodiments, the height of each winglet 75, 76 is equal to or less than the propeller radius (i.e., distance from the propeller center of rotation to the propeller tip) in order to keep the lifting surfaces of the winglets 75, 76 inside the propeller slipstream.

As shown by FIG. 1, the wings 25-28 have hinged flight control surfaces 95-98, respectively, for controlling the roll and pitch of the aircraft 20 during forward flight. FIG. 1 shows each of the flight control surface 95-98 in a neutral position for which each flight control surface 95-98 is aligned with the remainder of the wing surface. Thus, airflow is not significantly redirected or disrupted by the flight control surfaces 95-98 when they are in the neutral position. Each flight control surface 95-98 may be rotated upward, which has the effect of decreasing lift, and each flight control surface 95-98 may be rotated downward, which has the effect of increasing lift.

In some embodiments, the flight control surfaces 95, 96 of rear wings 25, 26 may be used to control roll, and the flight control surfaces 97, 98 of forward wings 27, 28 may be used to control pitch. In this regard, to roll the aircraft 20, the flight control surfaces 95, 96 may be controlled in an opposite manner during forward flight such that one of the flight control surfaces 95, 96 is rotated downward while the other flight control surface 95, 96 is rotated upward, as shown by FIGS. 2A and 2B, depending on which direction the aircraft 20 is to be rolled. The downward-rotated flight control surface 95 increases lift, and the upward-rotated flight control surface 96 decreases lift such that the aircraft 20 rolls toward the side on which the upward-rotated flight control surface 96 is located. Thus, the flight control surfaces 95, 96 may function as ailerons in forward flight.

The flight control surface 97, 98 may be controlled in unison during forward flight. When it is desirable to increase the pitch of the aircraft 20, the flight control surfaces 97, 98 are both rotated downward, as shown by FIGS. 2A and 2B, thereby increasing the lift of the wings 27, 28. This increased lift causes the nose of the aircraft 20 to pitch upward. Conversely, when it is desirable for the aircraft 20 to pitch downward, the flight control surfaces 97, 98 are both rotated upward thereby decreasing the lift generated by the wings 27, 28. This decreased lift causes the nose of the aircraft 20 to pitch downward. Thus, the flight control surfaces 97, 98 may function as elevators in forward flight.

Note that the flight control surfaces 95-98 may be used in other manners in other embodiments. For example, it is possible for the flight control surfaces 97, 98 to function as ailerons and for the flight control surfaces 95, 96 to function as elevators. Also, it is possible for any flight control surface 95-98 to be used for one purpose (e.g., as an aileron) during one time period and for another purpose (e.g., as an elevator) during another time period. Indeed, as will be described in more detail below, it is possible for any of the flight control surfaces 95-98 to control yaw depending on the orientation of the wings 25-28.

During forward flight, pitch, roll, and yaw may also be controlled via the propellers 41-48. As an example, to control pitch, the controller 110 may adjust the blade speeds of the propellers 45-48 on the forward wings 27, 28. An increase in blade speed increases the velocity of air over the forward wings 27, 28, thereby increasing lift on the forward wings 27, 28 and, thus, increasing pitch. Conversely, a decrease in blade speed decreases the velocity of air over the forward wings 27, 28, thereby decreasing lift on the forward wings 27, 28 and, thus, decreasing pitch. The propellers 41-44 may be similarly controlled to provide pitch control. In addition, increasing the blade speeds on one side of the aircraft 20 and decreasing the blade speeds on the other side can cause roll by increasing lift on one side and decreasing lift on the other. It is also possible to use blade speed to control yaw. Having redundant mechanisms for flight control helps to improve safety. For example, in the event of a failure of one or more flight control surfaces 95-98, the controller 110 may be configured to mitigate for the failure by using the blade speeds of the propellers 41-48.

It should be emphasized that the wing configurations described above, including the arrangement of the propellers 41-48 and flight control surfaces 95-98, as well as the size, number, and placement of the wings 25-28, are only examples of the types of wing configurations that can be used to control the aircraft's flight. Various modifications and changes to the wing configurations described above would be apparent to a person of ordinary skill upon reading this disclosure.

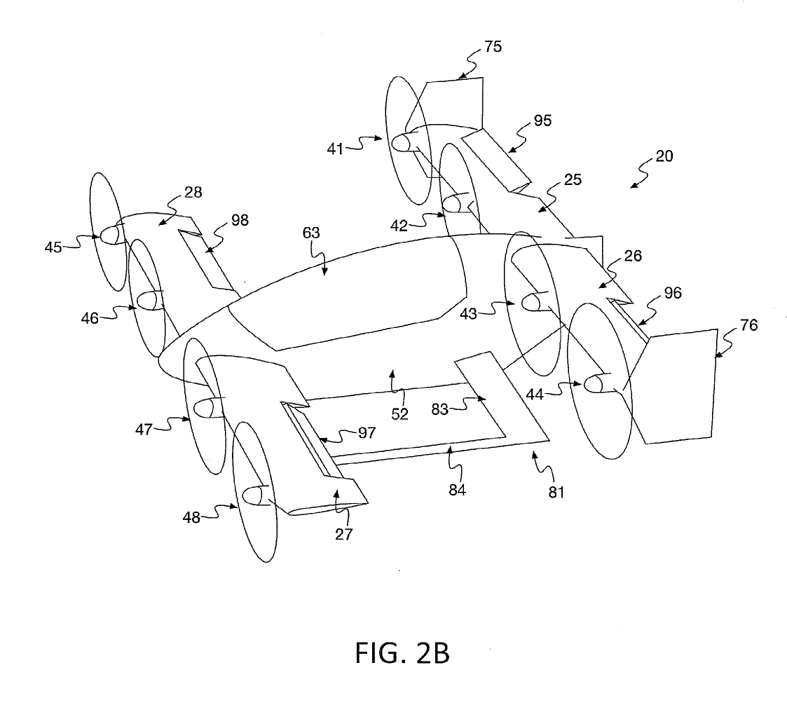

Referring to FIG. 3, the aircraft 20 may operate under the direction and control of an onboard controller 110, which may be implemented in hardware or any combination of hardware, software, and firmware. The controller 110 may be configured to control the flight path and flight characteristics of the aircraft 20 by controlling at least the propellers 41-48, the wings 25-28, and the flight control surfaces 95-98, as will be described in more detail below.

The controller 110 is coupled to a plurality of motor controllers 221-228 where each motor controller 221-228 is configured to control the blade speed of a respective propeller 41-48 based on control signals from the controller 110. As shown by FIG. 3, each motor controller 221-228 is coupled to a respective motor 231-238 that drives a corresponding propeller 41-48. When the controller 110 determines to adjust the blade speed of a propeller 41-48, the controller 110 transmits a control signal that is used by a corresponding motor controller 221-238 to set the rotation speed of the propeller's blades, thereby controlling the thrust provided by the propeller 41-48.

As an example, to set the blade speed of the propeller 41, the controller 110 transmits a control signal indicative of the desired blade speed to the corresponding motor controller 221 that is coupled to the propeller 41. In response, the motor controller 221 provides at least one analog signal for controlling the motor 231 such that it appropriately drives the propeller 41 to achieve the desired blade speed. The other propellers 42-48 can be controlled in a similar fashion. In some embodiments, each motor controller 221-228 (along with its corresponding motor 231-238) is mounted within a wing 25-28 directly behind the respective propeller 41-48 to which it is coupled. Further, the motor controllers 221-228 and motors 231-238 are passively cooled by directing a portion of the airflow through the wings and over heat sinks (not shown) that are thermally coupled to the motor controllers 221-228 and motors 231-238.

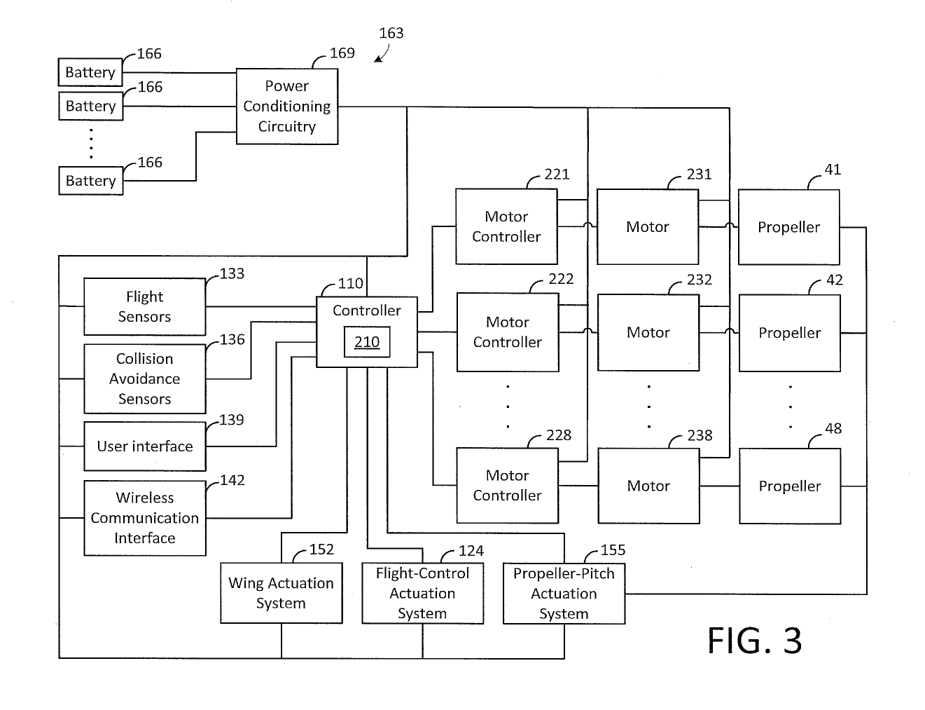

The controller 110 is also coupled to a flight-control actuation system 124 that is configured to control movement of the flight control surfaces 95-98 under the direction and control of the controller 110. FIG. 4 depicts an embodiment of the flight-control actuation system 124. As shown by FIG. 4, the system 124 comprises a plurality of motor controllers 125-128, which are coupled to a plurality of motors 135-138 that control movement of the flight control surfaces 95-98, respectively. The controller 110 is configured to provide control signals that can be used to set the positions of the flight control surfaces 95-98 as may be desired.

As an example, to set the position of the flight control surface 95, the controller 110 transmits a control signal indicative of the desired position to the corresponding motor controller 125 that is coupled to the flight control surface 95. In response, the motor controller 125 provides at least one analog signal for controlling the motor 135 such that it appropriately rotates the flight control surface 95 to the desired position. The other flight control surfaces 96-98 can be controlled in a similar fashion.

As shown by FIG. 3, to assist the controller 110 in its control functions, the aircraft 20 may have a plurality of flight sensors 133 that are coupled to the controller 110 and that provide the controller 110 with various inputs on which the controller 110 may make control decisions. As an example, the flight sensors 133 may include an airspeed sensor, an attitude sensor, a heading sensor, an altimeter, a vertical speed sensor, a global positioning system (GPS) receiver, or any other type of sensor that may be used for making control decisions for aviating and navigating the aircraft 20.

The aircraft 110 may also have collision avoidance sensors 136 that are used to detect terrain, obstacles, aircraft, and other objects that may pose a collision threat. The controller 110 is configured to use information from the collision avoidance sensors 136 in order to control the flight path of the aircraft 20 so as to avoid a collision with objects sensed by the sensors 136.

As shown by FIG. 3, the aircraft 20 may have a user interface 139 that can be used to receive inputs from or provide outputs to a user, such as a passenger. As an example, the user interface 139 may comprise a keyboard, keypad, mouse, or other device capable of receiving inputs from a user, and the user interface 139 may comprise a display device or a speaker for providing visual or audio outputs to the user. In some embodiments, the user interface 139 may comprise a touch-sensitive display device that has a display screen capable of displaying outputs and receiving touch inputs. As will be described in more detail below, a user may utilize the user interface 139 for various purposes, such as selecting or otherwise specifying a destination for a flight by the aircraft 20.

The aircraft 20 also has a wireless communication interface 142 for enabling wireless communication with external devices. The wireless communication interface 142 may comprise one or more radio frequency (RF) radios, cellular radios, or other devices for communicating across long ranges. As an example, during flight, the controller 110 may receive control instructions or information from a remote location and then control the operation of the aircraft 20 based on such instructions or information. The controller 110 may also comprise short-range communication devices, such as Bluetooth devices, for communicating across short ranges. As an example, a user may use a wireless device, such as cellular telephone, to provide input in lieu of or in addition to user interface 139. The user may communicate with the controller 110 using long range communication or alternatively using short range communication, such as when the user is physically present at the aircraft 20.

As shown by FIG. 3, the controller 110 is coupled to a wing actuation system 152 that is configured to rotate the wings 25-28 under the direction and control of the controller 110. In addition, the controller 110 is coupled to a propeller-pitch actuation system 155, which will be described in more detail below.

As further shown by FIG. 3, the aircraft 20 has an electrical power system 163 for powering various components of the aircraft 20, including the controller 110, the motor controllers 221-228, 125-128, and the motors 231-238, 135-138. In some embodiments, the motors 231-238 for driving the propellers 41-48 are exclusively powered by electrical power from the system 163, but it is possible for other types of motors 231-238 (e.g., fuel-fed motors) to be used in other embodiments.

The electrical system 163 has distributed power sources comprising a plurality of batteries 166 that are mounted on the frame 52 at various locations. Each of the batteries 166 is coupled to power conditioning circuitry 169 that receives electrical power from the batteries 166 and conditions such power (e.g., regulates voltage) for distribution to the electrical components of the aircraft 20. Specifically, the power conditioning circuitry 169 combines electrical power from multiple batteries 166 to provide at least one direct current (DC) power signal for the aircraft's electrical components. If any of the batteries 166 fail, the remaining batteries 166 may be used to satisfy the power requirements of the aircraft 20.

As indicated above, the controller 110 may be implemented in hardware, software, or any combination thereof. In some embodiments, the controller 110 includes at least one processor and software for running on the processor in order to implement the control functions described herein for the controller 110. Other configurations of the controller 110 are possible in other embodiments. Note that it is possible for the control functions to be distributed across multiple processors, such as multiple onboard processors, and for the control functions to be distributed across multiple locations. As an example, some control functions may be performed at one or more remote locations, and control information or instructions may be communicated between such remote locations and the aircraft 20 by the wireless communication interface 142 (FIG. 3) or otherwise.

As shown by FIG. 3, the controller 110 may store or otherwise have access to flight data 210, which may be used by the controller 110 for controlling the aircraft 20. As an example, the flight data 210 may define one or more predefined flight paths that can be selected by a passenger or other user. Using the flight data 210, the controller 110 may be configured to self-pilot the aircraft 20 to fly the selected flight path in order to reach a desired destination, as will be described in more detail hereafter.

As described above, in some embodiments, the wings 25-28 are configured to rotate under the direction and control of the controller 110. FIG. 1 shows the wings 25-28 positioned for forward flight in a configuration referred to herein as “forward-flight configuration” in which the wings 25-28 are positioned to generate sufficient aerodynamic lift for counteracting the weight of the aircraft 20 as may be desired for forward flight. In such forward-flight configuration, the wings 25-28 are generally positioned close to horizontal, as shown by FIG. 1, so that the chord of each wing 25-28 has an angle of attack for efficiently generating lift for forward flight. The lift generated by the wings 25-28 is generally sufficient for maintaining flight as may be desired.

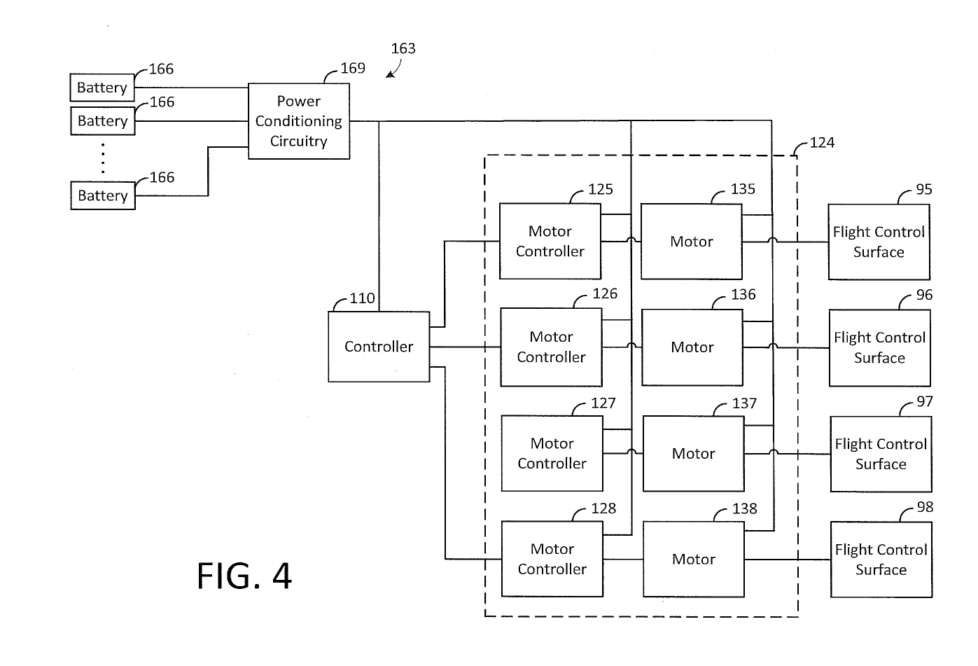

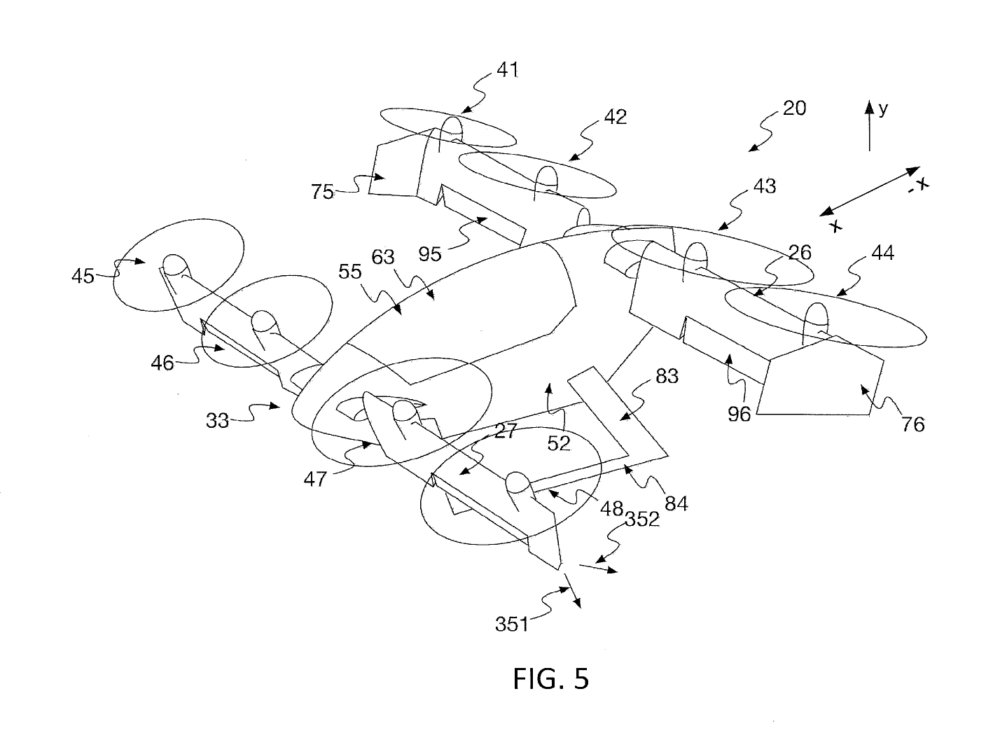

When desired, such as when the aircraft 20 nears its destination, the wings 25-28 may be rotated in order to transition the configuration of the wings 25-28 from the forward-flight configuration shown by FIG. 1 to a configuration, referred to herein as “hover configuration,” conducive for performing vertical takeoffs and landings. In the hover configuration, the wings 25-28 are positioned such that the thrust generated by the propellers 41-48 is sufficient for counteracting the weight of the aircraft 20 as may be desired for vertical flight. In such hover configuration, the wings 25-28 are positioned close to vertical, as shown by FIG. 5, so that thrust from the propellers 41-48 is generally directed upward to counteract the weight of the aircraft 20 in order to achieve the desired vertical speed, although the thrust may have a small offset from vertical for controllability, as will be described in more detail below. A top view of the aircraft 20 in the hover configuration with the wings 25-28 rotated such that the thrust from the propellers is substantially vertical is shown by FIG. 6.

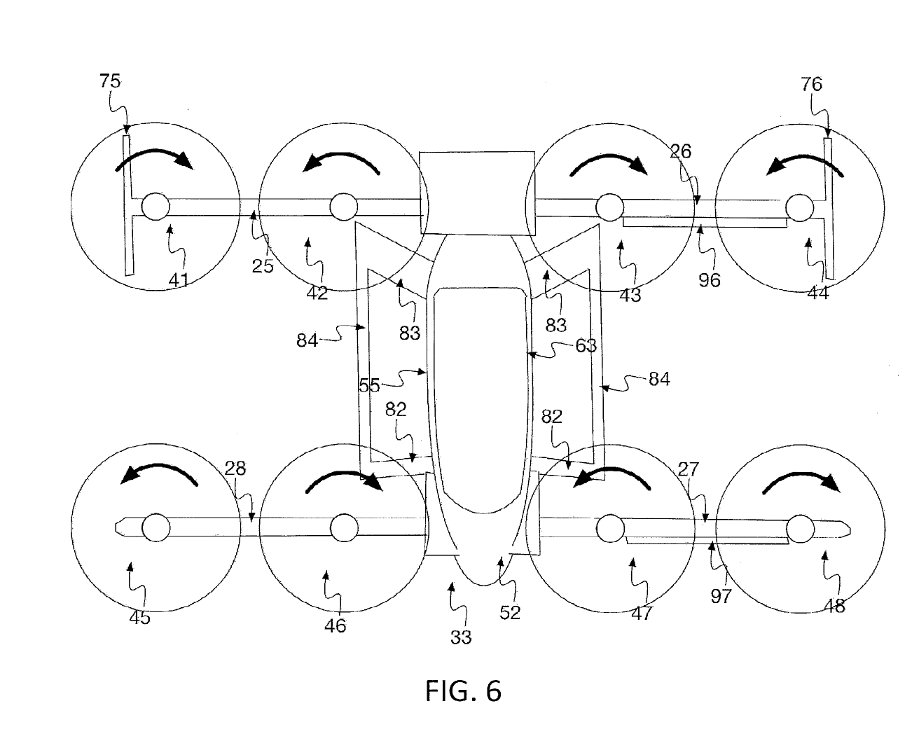

FIG. 7 depicts the aircraft 20 as it is transitioning between the forward-flight configuration and the hover configuration. As shown by FIG. 7, the wings 25-28 are positioned at an angle of about 45° relative to vertical. In such state, the weight of the aircraft 20 may be counteracted by a significant lift component generated by the wings and a significant thrust component generated by the propellers 41-48. That is, flight may be maintained by both a vertical component of aerodynamic lift from the wings 25-28 and a vertical component of thrust generated by the propellers 41-48. As the wings 25-28 are rotated to transition from the forward-flight configuration to the hover configuration, such as for vertical landing, the vertical component of lift from the wings 25-28 generally decreases while the vertical component of thrust from the propellers 41-48 generally increases offsetting the decrease in the vertical component of lift to achieve a desired vertical speed. Conversely, as the wings 25-28 are rotated to transition from the hover configuration to the forward-flight configuration, such as for vertical takeoff, the vertical component of thrust from the propellers 41-48 generally decreases while the vertical component of lift from the wings 25-28 generally increases offsetting the decrease in the vertical component of thrust to achieve a desired vertical velocity.

Notably, rotation of the wings 25-28 during a transition from the hover configuration to the forward-flight configuration permits the orientation of the wings 25-28 to be changed so that the angle of attack of the wings 25-28 is adjusted to efficiently generate lift as the direction of airflow changes. Specifically, the wings 25-28 can be rotated such that they remain substantially aligned with the direction of the flight path as the flight path changes from a substantially vertical path for takeoff to a substantially horizontal path for forward flight.

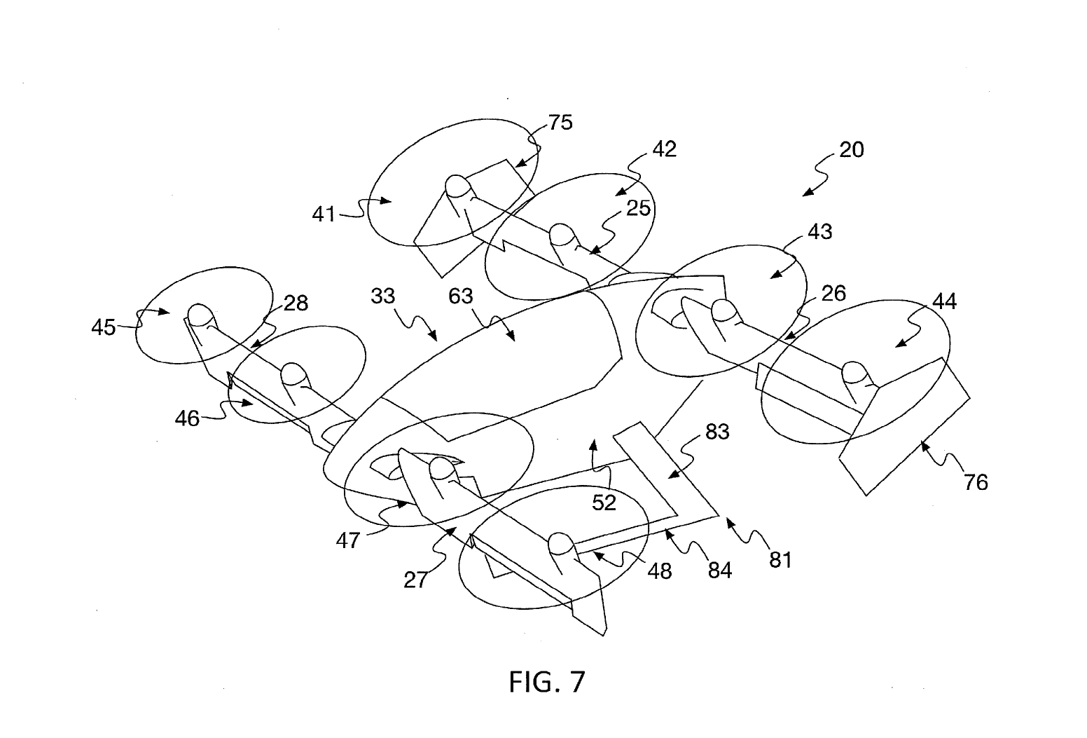

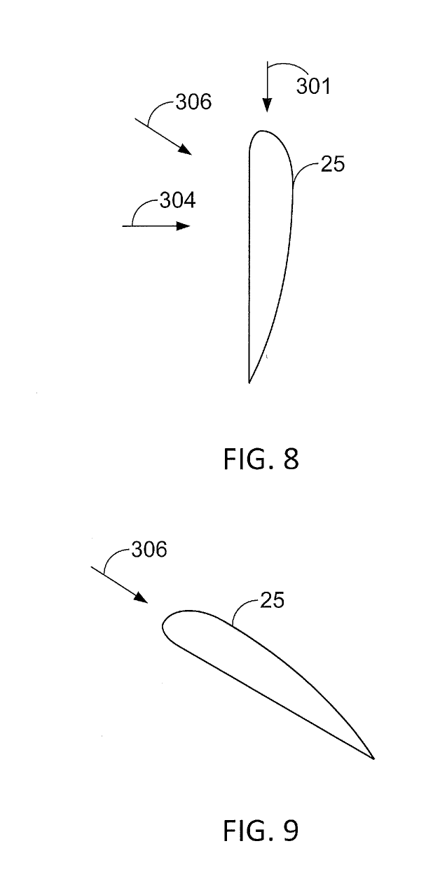

In this regard, FIG. 8 shows a side view of a wing 25 when it is positioned in the hover configuration. During vertical flight on takeoff, the approximate direction of airflow is represented by reference arrow 301. As a vertical takeoff is executed, the direction of airflow gradually changes from the direction shown by reference arrow 301 to a substantially horizontal direction, as represented by reference arrow 304. Reference arrow 306 represents the direction of the airflow at an arbitrary point from vertical flight to forward flight. As can be seen from FIG. 8, if the orientation of the wing 25 is not changed, the angle of attack of the wing 25 is increased as the aircraft 20 transitions from vertical flight to forward flight. As the angle of attack increases, airflow over the surface of the wing 25 becomes more disrupted, reducing the wing's lift-to-drag ratio, until the wing 25 eventually stalls. However, by continuously rotating the wing 25 during the transition by an amount corresponding to the change in airflow direction, the angle of attack can be kept in a more desirable range for efficiently producing lift and preventing a stall. In this regard, FIG. 9 shows the wing 25 after it has been rotated from the position shown by FIG. 8. As can be seen by comparing FIGS. 8 and 9, the wing 25 may have a similar angle of attack during the transition to forward flight (such as when the direction of airflow is indicated by reference arrow 306 in FIG. 9) relative to the angle of attack during vertical flight (such as when the direction of airflow is indicated by reference arrow 301 in FIG. 8).

Moreover, as the aircraft 20 transitions from vertical flight to forward flight during takeoff, the controller 110 may rotate the wings 25-28 such that the angle of attack of each wing 25-28 remains within a desired range for optimum wing performance. Specifically, the controller 110 can rotate the wings 25-28 such that they remain substantially aligned with the direction of the flight path in an effort to keep the angle of attack of each wing 25-28 substantially constant within an optimum range, thereby preventing or reducing flow separation from the wings 25-28 and keeping the wing dynamics of each wing 25-28 substantially linear during the transition. Further, blowing air over the wings 25-28 with the propellers 41-48 increases the speed of the airflow over the wings 25-28 and helps to reduce the effective angle of attack. Thus, using blown wings 25-28 enhances wing performance and helps to ensure that the wing dynamics remain substantially linear during the transition, thereby preventing or reducing airflow separation from the wings 25-28.

In a transition from forward flight to hover flight, a critical angle of attack for a stall can be quickly reached as the flight path changes from horizontal to vertical and as the wings 25-28 are rotated upward in order to position the propellers 41-48 for vertical flight in the hover configuration. By reducing the effective angle of attack, the use of the propellers 41-48 to blow air over the wings 25-28 helps to keep the wing dynamics substantially linear for a longer duration during the transition than would otherwise be possible without a blown-wing configuration, thereby helping to maintain controllability during the transition.

During a transition between the forward-flight configuration and the hover configuration, the controller 110 is also configured to adjust the blade pitch of the propellers 41-48. In this regard, for forward flight, it is generally desirable for the propeller blades to have a high pitch (i.e., a high angle of attack for the blades), and it is generally desirable for the propeller blades to have a low pitch (i.e., a low angle of attack for the blades) for hover flight. In some embodiments, the propellers 41-48 are implemented by variable-pitch propellers having a blade pitch that can be adjusted by mechanical components of the propeller-pitch actuation system 155 (FIG. 3), which operates under the direction and control of the controller 110. In this regard, the controller 110 controls the propeller-pitch actuation system 155 such that the blade pitch is adjusted during transitions between the forward-flight configuration and the hover configuration so that the blades are set to the appropriate pitch for the type of flight contemplated for the aircraft's configuration.

Note that the direction of rotation of the propeller blades, referred to hereafter as “blade direction,” may be selected based on various factors, including controllability while the aircraft 20 is in the hover configuration. In some embodiments, the blade directions of the outer propellers 41, 45 on one side of the fuselage 33 mirror the blade directions of the outer propellers 44, 48 on the other side of the fuselage 33. That is, the outer propeller 41 corresponds to the outer propeller 48 and has the same blade direction. Further, the outer propeller 44 corresponds to the outer propeller 45 and has the same blade direction. Also, the blade direction of the corresponding outer propellers 44, 45 is opposite to the blade direction of the corresponding outer propellers 41, 48. Thus, the outer propellers 41, 44, 45, 48 form a mirrored quad arrangement of propellers having a pair of diagonally-opposed propellers 41, 48 that rotate their blades in the same direction and a pair of diagonally-opposed propellers 44, 45 that rotate their blades in the same direction.

In the exemplary embodiment shown by FIG. 5, the outer propellers 41, 48 are selected for a clockwise blade direction (when viewed from the front of the aircraft 20), and the outer propellers 44, 45 are selected for a counter-clockwise blade direction (when viewed from the front of the aircraft 20) so as to realize the wingtip-mounting benefits previously described above for propellers 45, 48. However, such selection may be reversed, if desired so that blades of propellers 41, 48 rotate counter-clockwise and blades of propellers 44, 45 rotate clockwise.

In addition, the blade directions of the inner propellers 42, 46 on one side of the fuselage 33 mirror the blade directions of the inner propellers 43, 47 on the other side of the fuselage 33. That is, the inner propeller 42 corresponds to the inner propeller 47 and has the same blade direction. Further, the inner propeller 43 corresponds to the inner propeller 46 and has the same blade direction. Also, the blade direction of the corresponding inner propellers 43, 46 is opposite to the blade direction of the corresponding inner propellers 42, 47. Thus, the inner propellers 42, 43, 46, 47 form a mirrored quad arrangement of propellers having a pair of diagonally-opposed propellers 42, 47 that rotate their blades in the same direction and a pair of diagonally-opposed propellers 43, 46 that rotate their blades in the same direction. In other embodiments, the aircraft 20 may have any number of quad arrangements of propellers, and it is unnecessary for the propellers 41-48 to be positioned in the mirrored quad arrangements described herein.

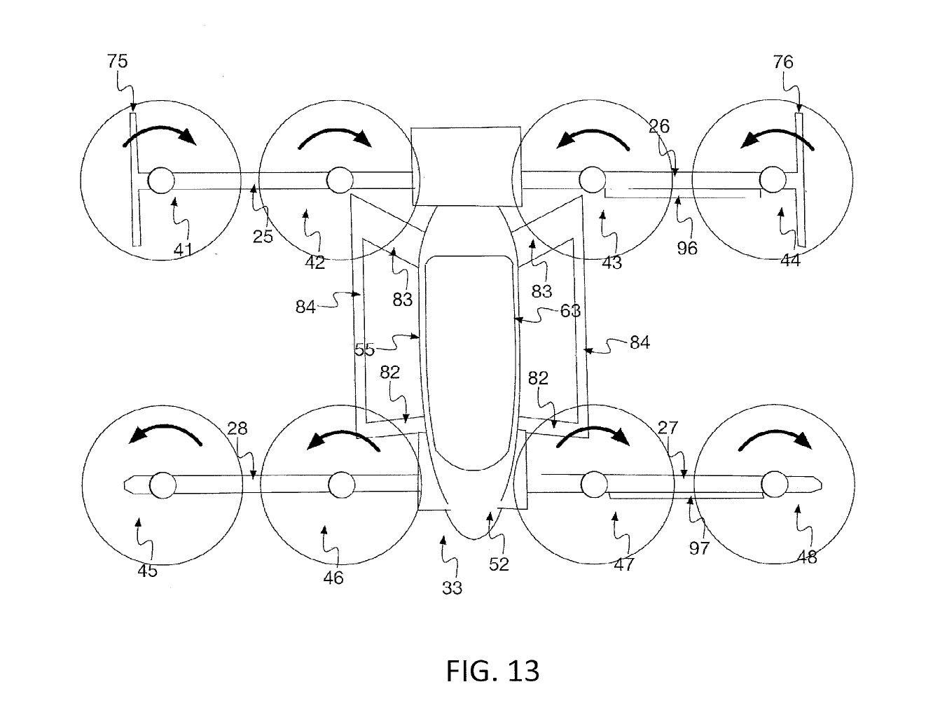

In the exemplary embodiment shown by FIG. 5, the corresponding inner propellers 42, 47 are selected for a counter-clockwise blade direction (when viewed from the front of the aircraft 20), and the corresponding inner propellers 43, 46 are selected for a clockwise blade direction (when viewed from the front of the aircraft 20). This selection has the advantage of ensuring that portions of the rear wings 25, 26 on the inboard side of propellers 42, 43 stall due to the upwash from propellers 42, 43 before the portions of the wings 25, 26 on the outboard side of the propellers 42, 43. This helps to keep the airflow attached to the surface of the wings 25, 26 where the flight control surfaces 95, 96 are located as angle of attack increases, thereby helping to keep the flight control surfaces 95, 96 functional for controlling the aircraft 20 as a stall is approached. However, such selection may be reversed, if desired, so that blades of propellers 42, 47 rotate clockwise and blades of propellers 43, 46 rotate counter-clockwise, as shown by FIG. 13. Yet other blade direction combinations are possible in other embodiments.

By mirroring the blade directions in each quad arrangement, as described above, certain controllability benefits can be realized. For example, corresponding propellers (e.g., a pair of diagonally-opposed propellers within a mirrored quad arrangement) may generate moments that tend to counteract or cancel so that the aircraft 20 may be trimmed as desired. The blade speeds of the propellers 41-48 can be selectively controlled to achieve desired roll, pitch, and yaw moments. As an example, it is possible to design the placement and configuration of corresponding propellers (e.g., positioning the corresponding propellers about the same distance from the aircraft's center of gravity) such that their pitch and roll moments cancel when their blades rotate at certain speeds (e.g., at about the same speed). In such case, the blade speeds of the corresponding propellers can be changed (i.e., increased or decreased) at about the same rate or otherwise for the purposes of controlling yaw, as will be described in more detail below, without causing roll and pitch moments that result in displacement of the aircraft 20 about the roll axis and the pitch axis, respectively. By controlling all of the propellers 41-48 so that their roll and pitch moments cancel, the controller 110 can vary the speeds of at least some of the propellers to produce desired yawing moments without causing displacement of the aircraft 20 about the roll axis and the pitch axis. Similarly, desired roll and pitch movement may be induced by differentially changing the blade speeds of propellers 41-48. In other embodiments, other techniques may be used to control roll, pitch, and yaw moments.

In the event of a failure of any propeller 41-48, the blade speeds of the other propellers that remain operational can be adjusted in order to accommodate for the failed propeller while maintaining controllability. In some embodiments, the controller 110 stores predefined data, referred to hereafter as “thrust ratio data,” that indicates desired thrusts (e.g., optimal thrust ratios) to be provided by the propellers 41-48 for certain operating conditions (such as desired roll, pitch, and yaw moments) and propeller operational states (e.g., which propellers 41-48 are operational). Based on this thrust ratio data, the controller 110 is configured to control the blade speeds of the propellers 41-48, depending on which propellers 41-48 are currently operational, to achieve optimal thrust ratios in an effort to reduce the total thrust provided by the propellers 41-48 and, hence, the total power consumed by the propellers 41-48 while achieving the desired aircraft movement. As an example, for hover flight, the thrust ratios that achieve the maximum yawing moment for a given amount of total thrust may be determined.

In some embodiments, the thrust ratio data is in the form of matrices or other data structures that are respectively associated with certain operational states of the propellers 41-48. For example, one matrix may be used for a state in which all of the propellers 41-48 are operational, another matrix may be used for a state in which one propeller (e.g., propeller 42) has failed, and yet another matrix may be used for a state in which another propeller (e.g., propeller 43) as has failed. There may be at least one matrix associated with each possible propeller operational state.

Each matrix may be defined based on tests performed for the propeller operational state with which it is associated in order to derive a set of expressions (e.g., coefficients) that can be used by the controller 110 to determine the desired thrusts for such operational state. As an example, for a given operational state (such as a failure of a particular propeller 41-48), tests may be performed to determine the optimal ratio of thrusts for the operational propellers in order to keep the aircraft 20 trimmed. A matrix associated with such operational state may be defined such that, when values indicative of the desired flight parameters (e.g., a value indicative of the desired amount of yaw moment, a value indicative of the desired amount of pitch moment, a value indicative of the desired amount of roll moment, and a value indicative of the desired amount of total thrust) are mathematically combined with the matrix, the result provides at least one value indicative of the optimal thrust for each operational propeller in order to achieve the desired flight parameters. Thus, after determining the desired flight parameters for the aircraft 20 during operation, the controller 110 may determine the current propeller operational state of the aircraft 20 and then analyze the thrust ratio data based on such operational state and one or more of the flight parameters to determine a value for controlling at least one of the propellers 41-48. As an example, the controller 110 may be configured to combine values indicative of the desired flight parameters with the matrix that is associated with the current propeller operational state of the aircraft 20 in order to determine at least one value for controlling each operational propeller 41-48. Note that the motor controllers 221-228 (FIG. 3) or sensors (not specifically shown) for monitoring the operational states of the propellers 41-48 may inform the controller 110 about which propellers 41-48 are currently operational.

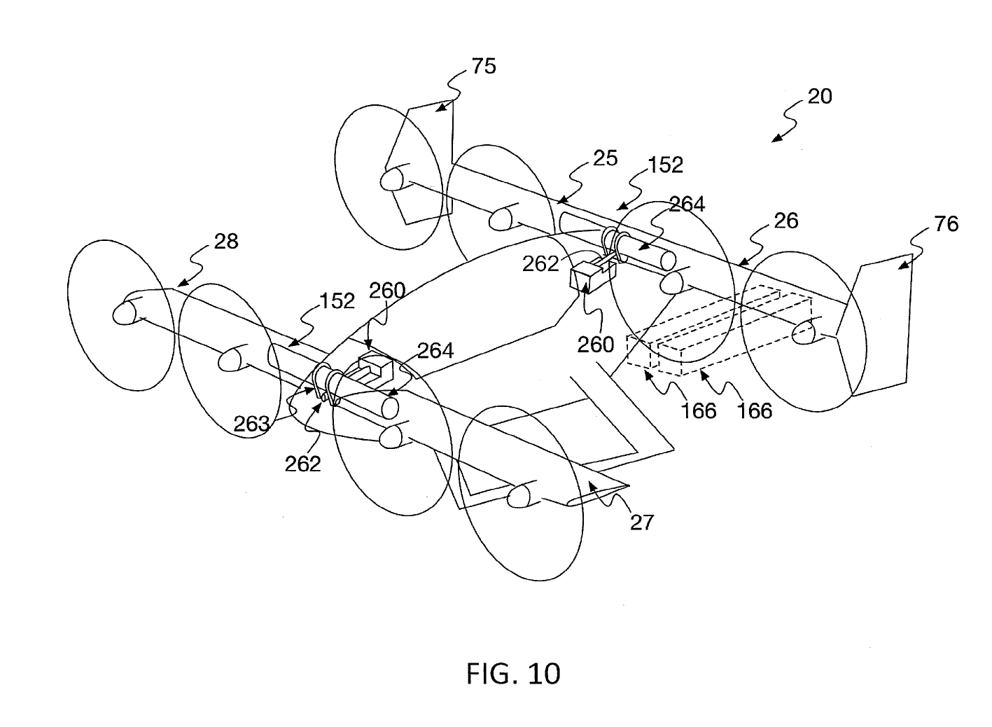

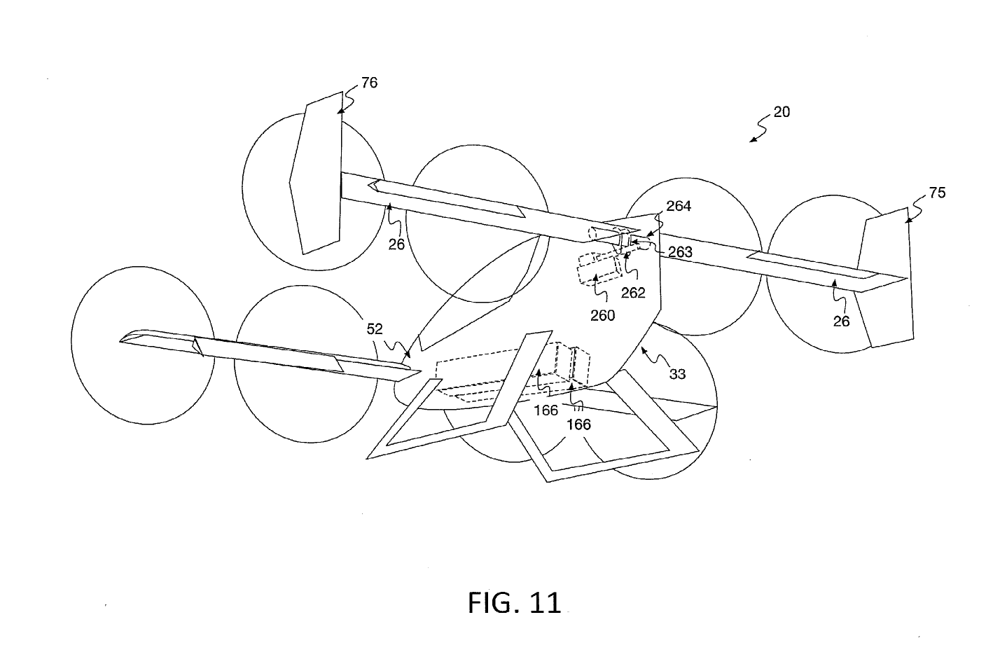

FIGS. 10 and 11 show exemplary components of the wing actuation system 152 for rotating the wings 25-28, as described herein. As shown by FIGS. 10 and 11. The wing actuation system 152 comprises a plurality a linear actuators 260 that are coupled to the rear wings 25, 26 and the forward wings 27, 28, respectively. As an example, a linear actuator 260 having a rod 262 is coupled to and rotates the rear wings 25, 26 under the direction and control of the controller 110. The rod 262 passes through a rotational element 263 through which a spar 264 for the wings 25, 26 also passes. The wings 25, 26 are coupled to the spar 264 such that they rotate as the spar 264 is rotated by the linear actuator 260. In this regard, the linear actuator 260 is designed to move the rod 262 linearly, and the linear movement of the rod 262 is converted into rotational movement of the spar 264, thereby rotating the wings 25, 26 relative to the fuselage 33. The linear actuator 260 coupled to the forward wings 27, 28 is designed to rotate the forward wings 27, 28 in the same way. In other embodiments, other types of devices and configurations for rotating the wings 25-28 are possible. FIGS. 10 and 11 also show exemplary batteries 166 that may be used for the aircraft 20, and FIG. 10 showing the batteries 166 removed from the fuselage 33 for illustrative purposes. Other configurations and locations of the batteries 166 are possible.

Note that, in some embodiments, the aircraft 20 does not have a rudder for controlling yaw, although it is possible for the aircraft 20 to have a rudder in other embodiments. In the embodiment depicted by FIG. 1, yaw stability is provided by the winglets 75, 76 and the rear struts 83 for forward flight, and a rudder is unnecessary. Further, there are various techniques that can be used to control yaw for hover flight, as will be described in more detail below.

As an example, differential torque from the propeller motors 231-238 can be used to control yaw in the hover configuration. In this regard, due to air resistance acting on the spinning blades of a propeller 41-48, a spinning propeller 41-48 applies torque on the aircraft 20 through the motor 231-238 that is spinning its blades. This torque generally varies with the speed of rotation. By varying the speeds at least some of the propellers 41-48 differently, differential toque can be generated by the spinning propellers 41-48 for causing the aircraft 20 to yaw or, in other words, rotate about its yaw axis.

Note that the amount of force that can be applied by differential torque for yaw control is limited. Further, increasing the efficiency of the propellers 41-48 in order to reduce parasitic forces, such as air resistance, has the effect of reducing the amount of differential torque that can be applied to the aircraft 20 by the propellers 41-48. In at least some embodiments, the aircraft 20 is designed to use other techniques to provide yaw control in addition to or instead of differential torque.

As an example, by using a tilted-wing configuration for which the wings 25-28 are rotatable relative to the fuselage 33, as described above, the controller 110 can be configured to selectively tilt the wings 25-28 for providing yaw control when the aircraft 20 is in the hover configuration. By controlling wing tilt, the controller 110 can position the propellers 41-48 such their thrust vectors have a desired horizontal component. Even a small offset from vertical, such as around 10° or less, can induce significant lateral forces for controlling yaw considering the magnitude of the thrust vectors that are needed to support the weight of the aircraft 20. In this regard, if it is assumed that an aircraft 20 has eight propellers 41-48, as shown by FIG. 5, and has a mass of around 600 kilograms, then each propeller 41-48 may be configured to provide sufficient thrust for supporting the weight generated by approximately ⅛^{th} of the aircraft's mass or about 75 kilograms. Tilting the wings 25-28 such that the direction of a propeller thrust vector is just a few degrees from vertical results in a horizontal component of the thrust vector that is small relative to the total thrust provided but that is significant in terms of yaw control.

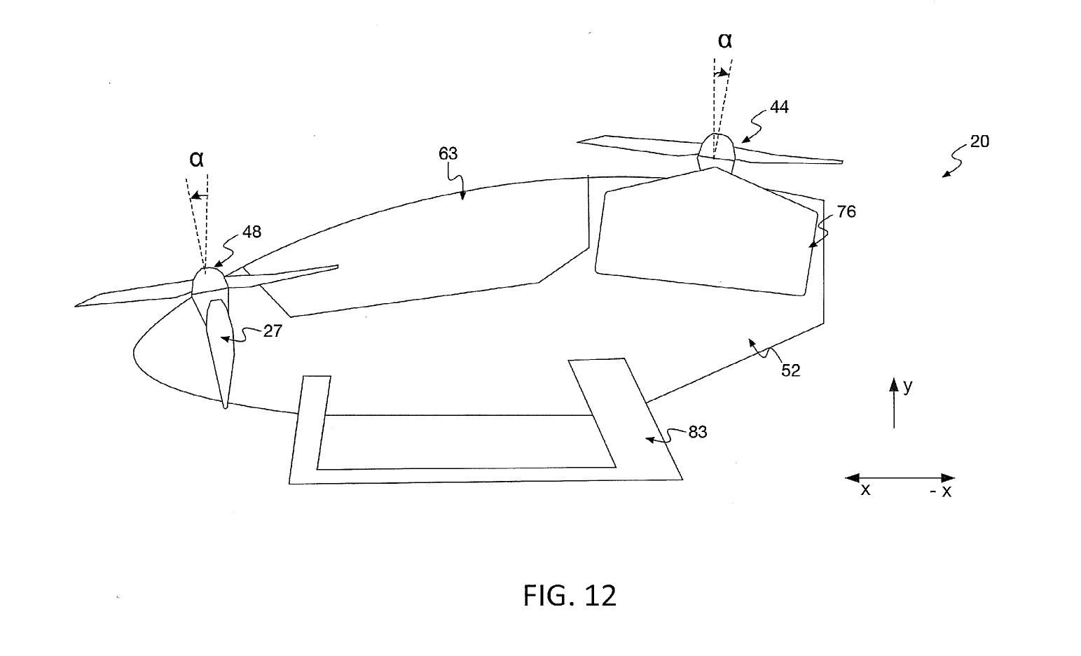

Note that FIGS. 5 and 12 depict the aircraft 20 after the wings 25-28 have been slightly tilted by an angle, α, from vertical so that the thrust generated by each propeller 41-48 is oriented in a direction that is offset from vertical by a few degrees. Specifically, the rear wings 25, 26 are slightly tilted in a direction toward the rear of the aircraft 20 such that the thrust generated by the propellers 41-44 is at a small angle relative to vertical. In this regard, the horizontal component of the thrust from the propellers 41-44 is in the negative (−) x-direction. Also, the forward wings 27, 28 are tilted in a direction toward the front of the aircraft 20 such that the thrust generated by the propellers 45-48 is at a small angle relative to vertical. Thus, the horizontal component of the thrust from the propellers 45-48 is in the positive (+) x-direction.

In some embodiments, the orientation of each propeller 41-48 is stationary relative to the wing on which it is mounted so that the direction of thrust generated by the propeller 41-48 relative to its wing is constant. Thus, to orient a propeller 41-48 in a direction that is offset from vertical, as described above, the propeller's wing is sufficiently tilted to position the propeller 41-48 in the desired orientation. In other embodiments, a propeller 41-48 can be designed to tilt or otherwise move relative to the wing on which it is mounted in order to help control the orientation of the propeller relative to the fuselage 33.

There are various ways that the propellers 41-48 can be controlled when tilted, as shown by FIG. 5. As an example, the blade speeds of one or more of the propellers 41, 42, 45, 46 on one side of the aircraft 20 may be increased, and the blade speeds of one or more of the propellers 43, 44, 47, 48 on the other side of the aircraft 20 may be decreased in order to yaw the aircraft 20 in one direction. For example, the blade speeds of propellers 41, 42, 47, 48 may be increased, and the blade speeds of propellers 43, 44, 45, 46 may be decreased in order to generate horizontal thrust components for yawing the aircraft 20 in one direction. Alternatively, the blade speeds of propellers 43, 44, 45, 46 may be increased, and the blade speeds of propellers 41, 42, 47, 48 may be decreased in order to generate horizontal thrust components for yawing the aircraft 20 in the opposite direction. Yet other techniques for controlling yaw are possible in other examples. As an example, changing the angle of tilt of the rear wings 25, 26 or the forward wings 27, 28 changes the horizontal thrust components of the propellers on the moving wings resulting in changes in yaw movement.

It is also possible to tilt the wings 25-28 differently relative to the embodiment shown by FIG. 5. As an example, the rear wings 25, 26 may be tilted in a direction toward the front of the aircraft 20 such that the horizontal component of the thrust from the propellers 41-44 is in the positive (+) x-direction, and the forward wings 27, 28 may be tilted in a direction toward the rear of the aircraft 20 such that the horizontal component of the thrust from the propellers 45-48 is in the negative (−) x-direction.

Note that tilting the forward wings 27, 28 and the rear wings 25, 26 in opposite directions, as shown by FIG. 5, permits the propeller thrust vectors to be used to control yaw without causing the aircraft 20 to move horizontally along its roll axis (e.g., in the x-direction). In this regard, propeller thrust may generate moments that cause the aircraft 20 to rotate about its yaw axis while the horizontal components of the thrust vectors counteract each other. Thus, it is possible for the controller 110 to set the propeller blade speeds such that yawing is induced while the horizontal components of the thrust vectors cancel so that the aircraft 20 does not move laterally along its roll axis. If lateral movement along its roll axis is desired while in the hover configuration, either the rear wings 25, 26 or the forward wings 27, 28 may be tilted, or all of the wings 25-28 may be tilted in the same direction such that the horizontal components of the thrust vectors are in the same direction (i.e., in either the positive (+) or negative (−) x-direction depending on the desired direction of tilt). For example, if a desired destination is close to the aircraft's takeoff location, it may be cost effective to fly to the destination in the hover configuration using wing tilt to control the thrusting force for forward flight. In such an example, the vertical components of the propeller thrust vectors counteract the vehicle's weight and control the aircraft's vertical speed, and the horizontal components of the propeller thrust vectors control the vehicle's horizontal speed.

In some embodiments, the rear wings 25, 26 are configured to rotate in unison, and the forward wings 27, 28 are configured to rotate in unison. In such embodiments, the same mechanical components (e.g., a single motor or linear actuator) may be used to rotate both rear wings 25, 26, and the same mechanical components (e.g., a single motor linear actuator) may be used to rotate both forward wings 27, 28. Using the same components to rotate multiple wings helps to conserve weight and, thus, power. However, in other embodiments it is possible for each wing 25-28 to be rotated independent of the other wings. As an example, to yaw the aircraft 20 in one direction, the wings 25, 27 on one side of the aircraft 20 may be rotated in one direction while the wings 26, 28 on the other side of the aircraft 20 are rotated in the opposite direction. In such an embodiment, the blade speeds of the propellers 20 may be the same, and the speed of lateral rotation of the aircraft 20 (i.e., yaw speed) may be controlled by the angles of wing tilt. If desired, the blade speeds of the propellers 20 may also be varied to provide additional yaw control.

In addition, while in the hover configuration, the controller 110 may selectively control the flight control surfaces 95-98 in order to control yaw (e.g., augment the yaw control provided by the propellers 41-48 or other components). In this regard, actuating a flight control surface 95-98 such that it is pivoted from a neutral position generally redirects the airflow from one or more of the propellers 41-48 mounted on the same wing 25-28. As an example, in FIG. 5, air from the propellers 47, 48 is generally directed by the wing 27 in a direction indicated by reference arrow 351 when the flight control surface 97 is in the neutral position. By actuating the flight control surface 97, as shown by FIG. 5, at least some airflow from the propellers 47, 48 is redirected in the direction indicated by reference arrow 352. The momentum of the airflow imparts a force onto the aircraft 20 that is generally in the opposite direction relative to the airflow's direction upon leaving the aircraft 20. By changing the direction of the airflow, a flight control surface 97 changes the direction of the force that is imparted onto the aircraft 20 by the momentum of the airflow. Thus, the controller 110 may control yaw by controlling the positions of the flight control surfaces 95-98. As an example, the controller 110 may cause the flight control surfaces 96, 97 on one side of the aircraft 20 to rotate from neutral in one direction and simultaneously cause the flight control surfaces 97, 98 on the opposite side of the aircraft 20 to rotate in the opposite direction in order to increase or decrease rotational movement of the aircraft 20 about the yaw axis.

In other examples, the flight control surfaces 95-98 may be actuated in other ways to control yaw in any desired manner. Indeed, it is possible for any of the flight control surfaces 95-98 to be controlled in any manner, and it is unnecessary for the operation of the flight control surfaces 95-98 in the hover configuration to correspond to their operation in the forward-flight configuration. As an example, if the flight control surfaces 95, 96 are operated as ailerons in the forward-flight configuration such that they are rotated in opposite directions, it is unnecessary for the flight control surfaces 95, 96 to be controlled to rotate in opposite directions in the hover configuration. That is, the flight control surfaces 95-98 are independently controllable by the controller 110.

Accordingly, various embodiments of VTOL aircraft 20 described herein provide similar advantages relative to other VTOL aircraft, such as helicopters, by for example allowing the aircraft 20 to operate independently from airports, if desired. However, by using electrically-powered propellers in an arrangement that permits low tip speed for forward flight, the noise produced by the VTOL aircraft 20 described herein can be considerably less. Further, the use of multiple propellers as described provides propulsion and flight control redundancies that significantly increase safety, and the use of tilted wings that are blown by the propellers improves aerodynamics and makes it easier to control the aircraft 20, thereby simplifying the aircraft's design. Through efficient design of the aircraft's aerodynamics and control, the performance and range of the aircraft 20 can be significantly increased to realize a cost-effective solution for various aerial-transport applications.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims. As a mere example, the tilted-wing configuration is described in various embodiments above in the context of a self-piloted, electrically-powered, VTOL aircraft. However, such a tilted-wing configuration (and other aspects of the aircraft 20 described herein) may be employed with respect to other types of aircraft.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A self-piloted, electric vertical takeoff and landing (VTOL) aircraft, comprising:
a fuselage having a first side and a second side that is opposite to the first side;
a first rear wing rotatable relative to the fuselage and positioned on the first side of the fuselage;
a second rear wing rotatable relative to the fuselage and positioned on the second side of the fuselage;
a first forward wing rotatable relative to the fuselage and positioned on the first side of the fuselage;
a second forward wing rotatable relative to the fuselage and positioned on the second side of the fuselage;
a first propeller coupled to the first forward wing and positioned to blow air over the first forward wing;
a second propeller coupled to the second forward wing and positioned to blow air over the second forward wing;
a third propeller coupled to the first rear wing and positioned to blow air over the first rear wing;
a fourth propeller coupled to the second rear wing and positioned to blow air over the second rear wing; and
a controller configured to rotate each of the wings relative to the fuselage from a forward flight position to a hover position, wherein a direction of thrust for the first propeller is offset from vertical when the first forward wing is in its respective hover position thereby providing a first horizontal thrust component from the first propeller, wherein a direction of thrust for the second propeller is offset from vertical when the second forward wing is in its respective hover position thereby providing a second horizontal thrust component from the second propeller, wherein a direction of thrust for the third propeller is offset from vertical when the first rear wing is in its respective hover position thereby providing a third horizontal thrust component from the third propeller, wherein a direction of thrust for the fourth propeller is offset from vertical when the second rear wing is in its respective hover position thereby providing a fourth horizontal thrust component from the fourth propeller, and wherein the controller is configured to control yaw of the aircraft by adjusting the thrusts for the first, second, third, and fourth propellers such that the horizontal thrust components induce yawing movements of the aircraft for hover flight.

2. The aircraft of claim 1, wherein the first horizontal thrust component and the second horizontal thrust component counteract the third horizontal thrust component and the fourth horizontal thrust component when each of the wings is in its respective hover position.

3. The aircraft of claim 1, wherein the first propeller is wing-tip mounted on the first forward wing, and wherein the second propeller is wing-tip mounted on the second forward wing.

4. The aircraft of claim 1, further comprising:
a fifth propeller coupled to the first forward wing and positioned to blow air over the first forward wing;
a sixth propeller coupled to the second forward wing and positioned to blow air over the second forward wing;
a seventh propeller coupled to the first rear wing and positioned to blow air over the first rear wing; and
an eighth propeller coupled to the second rear wing and positioned to blow air over the second rear wing.

5. The aircraft of claim 1, wherein the first forward wing has a first movable flight control surface, wherein the second forward wing has a second movable flight control surface, wherein the first rear wing has a third movable flight control surface, wherein the second rear wing has a fourth movable flight control surface, and wherein the controller is configured to adjust each of the movable flight control surfaces for controlling the yawing movements of the aircraft for hover flight.

6. The aircraft of claim 5, wherein the controller is configured to adjust at least one of the movable flight control surfaces for controlling pitch or roll of the aircraft during forward flight.

7. A vertical takeoff and landing (VTOL) aircraft, comprising:
a fuselage;
a plurality of wings coupled to the fuselage in a tandem-wing configuration, the plurality of wings including at least one, rear wing rotatable relative to the fuselage and at least one forward wing rotatable relative to the fuselage;
a first propulsion device coupled to the forward wing;
a second propulsion device coupled to the rear wing; and
a controller configured to rotate the forward wing relative to the fuselage from a first position for forward flight to a second position for hover flight, wherein a direction of thrust for the first propulsion device is offset from vertical when the forward wing is in the second position thereby providing a first horizontal thrust component from the first propulsion device, the controller further configured to rotate the rear wing relative to the fuselage from a third position for forward flight to a fourth position for hover flight, wherein a direction of thrust for the second propulsion device is offset from vertical when the rear wing is in the fourth position thereby providing a second horizontal thrust component from the second propulsion device, and wherein the controller is configured to control yaw of the aircraft in hover flight based on the first horizontal thrust component and the second horizontal thrust component.

8. The aircraft of claim 7, wherein the first horizontal thrust component counteracts the second horizontal thrust component when the forward wing is in the second position for hover flight and the rear wing is in the fourth position for hover flight.

9. The aircraft of claim 8, wherein the fuselage has a first side and a second side that is opposite to the first side, wherein the forward wing is positioned on the first side of the fuselage and the rear wing is positioned on the second side of the fuselage such that a roll moment generated by a vertical thrust component of the first propulsion device when the forward wing is in the second position for hover flight counteracts a roll moment generated by a vertical thrust component of the second propulsion device when the rear wing is in the fourth position for hover flight.

10. The aircraft of claim 9, wherein a center of gravity of the aircraft is between the forward wing and the rear wing such that a pitch moment generated by the vertical thrust component of the first propulsion device when the forward wing is in the second position for hover flight counteracts a pitch moment generated by the vertical thrust component of the second propulsion device when the rear wing is in the fourth position for hover flight.

11. The aircraft of claim 7, wherein the first propulsion device comprises a first propeller positioned to blow air over the forward wing, and wherein the second propulsion device comprises a second propeller positioned to blow air over the rear wing.

12. The aircraft of claim 11, wherein the first propeller is wingtip-mounted on the forward wing.

13. The aircraft of claim 11, wherein the controller is configured to self-pilot the aircraft during forward flight and hover flight.

14. The aircraft of claim 11, wherein the controller is configured to control rotation of the forward wing from the second position to the first position during a transition from hover flight to forward flight such that wing dynamics of the forward wing remain substantially linear thereby preventing a stall of the forward wing during the transition.

15. The aircraft of claim 11, wherein the first propeller and the second propeller are electrically-powered.

16. The aircraft of claim 15, further comprising a plurality of batteries coupled to each of the first propeller and the second propeller.

17. The aircraft of claim 7, wherein the forward wing has a first movable flight control surface, and wherein the controller is configured to move the first movable flight control surface for controlling yaw in hover flight such that the first movable flight control surface redirects an airflow from the first propulsion device.

18. The aircraft of claim 17, wherein the controller is configured to control the first movable flight control surface during forward flight for controlling pitch or roll of the aircraft.

19. The aircraft of claim 17, wherein the rear wing has a second movable flight control surface, and wherein the controller is configured to move the second movable flight control surface for controlling yaw in hover flight such that the second movable flight control surface redirects an airflow from the second propulsion device.

20. The aircraft of claim 7, further comprising:
a third propulsion device coupled to the rear wing; and
a fourth propulsion device coupled to the forward wing.

21. The aircraft of claim 20, wherein the plurality of wings includes a second forward wing rotatable relative to the fuselage and a second rear wing rotatable relative to the fuselage, and wherein the aircraft further comprises:
a fifth propulsion device coupled to the second forward wing;
a sixth propulsion device coupled to the second forward wing;
a seventh propulsion device coupled to the second rear wing; and
an eighth propulsion device coupled to the second rear wing.

22. A method for controlling a vertical takeoff and landing (VTOL) aircraft having a plurality of wings arranged in a tandem-wing configuration, comprising:
generating thrust by a first propulsion device coupled to a first wing of the plurality of wings;
generating thrust by a second propulsion device coupled to a second wing of the plurality of wings;
rotating the first wing relative to a fuselage of the aircraft from a first position for forward flight to a second position for hover flight, wherein a direction of the thrust generated by the first propulsion device is offset from vertical when the first wing is in the second position thereby providing a first horizontal thrust component;
rotating the second wing relative to the fuselage from a third position for forward flight to a fourth position for hover flight, wherein a direction of the thrust generated by the second propulsion device is offset from vertical when the second wing is in the fourth position thereby providing a second horizontal thrust component; and
controlling yaw of the aircraft with a controller during hover flight, wherein the controlling comprises adjusting the thrust generated by the first propulsion device and the thrust generated by the second propulsion device while the first wing is in the second position for hover flight and the second wing is in the fourth position for hover flight such that the first horizontal thrust component and the second horizontal thrust component induce a yawing movement of the aircraft during hover flight.

23. The method of claim 22, wherein the first horizontal thrust component counteracts the second horizontal thrust component when the first wing is in the second position for hover flight and the second wing is in the fourth position for hover flight.

24. The method of claim 22, wherein a center of gravity for the aircraft is between the first wing and the second wing such that a pitch moment generated by the first propulsion device when the first wing is in the second position for hover flight counteracts a pitch moment generated by the second propulsion device when the second wing is in the fourth position for hover flight.

25. The method of claim 22, wherein the first wing and the second wing are positioned on opposite sides of the fuselage such that a roll moment generated by the first propulsion device when the first wing is in the second position for hover flight counteracts a roll moment generated by the second propulsion device when the second wing is in the fourth position for hover flight.

26. The method of claim 22, further comprising:
blowing air over the first wing with the first propulsion device; and
blowing air over the second wing with the second propulsion device.

27. The method of claim 22, wherein the first propulsion device and the second propulsion device are electrically-powered.

28. The method of claim 22, further comprising rotating the first wing relative to a fuselage of the aircraft from the second position for hover flight to the first position for forward flight such that wing dynamics of the first wing remain substantially linear thereby preventing a stall of the first wing.

29. The method of claim 22, wherein the controlling comprises:
adjusting a movable flight control surface of the first wing; and
adjusting a movable flight control surface of the second wing.

30. The method of claim 29, further comprising controlling roll or pitch of the aircraft with the controller during forward flight, wherein the controlling the roll or pitch of the aircraft, comprises:
adjusting the movable flight control surface of the first wing; and
adjusting the movable flight control surface of the second wing.

31. The method of claim 22, further comprising:
generating thrust by a third propulsion device coupled to the first wing; and
generating thrust by a fourth propulsion device coupled to the second wing.

32. The method of claim 31, further comprising:
generating thrust by a fifth propulsion device coupled to a third wing of the plurality of wings;
generating thrust by a sixth propulsion device coupled to the third wing;
generating thrust by a seventh propulsion device coupled to a fourth wing of the plurality of wings; and
generating thrust by an eighth propulsion device coupled to the fourth wing.

33. The method of claim 22, further comprising self-piloting the VTOL aircraft during vertical takeoffs and landings with the controller.
